(19) United States
(12) Patent Application Publication
(10) Pub. No.: US 2003/0232203 A1
(43) Pub. Date: Dec. 18, 2003

(54) Porous polymers: compositions and uses thereof

(75) Inventors: Senol Mutlu, Ann Arbor, MI (US); Ponnambalam Selvaganapathy, Ann Arbor, MI (US); Carlos Mastrangelo, Bedford, NH (US); Frantisek Svec, Alameda, CA (US); Jean M.J. Frechet, Oakland, CA (US); Cong Yu, Hong Kong (HK)

Correspondence Address: Peter G. Carroll, MEDLEN & CARROLL, LLP, Suite 350, 101 Howard Street, San Francisco, CA, 94105, US

(73) Assignees: The Regents Of The University Of Michigan, Ann Arbor, MI; The Regents Of The University Of California, Oakland, CA

(21) Appl. No.: 10/346,300

(22) Filed: Jan. 17, 2003

Related U.S. Application Data
(60) Provisional application No. 60/349,529, filed on Jan. 18, 2002.

(51) Int. Cl. B32B 13/12

(52) U.S. Cl. 428/451; 428/500

(57) ABSTRACT

A composition, method and use is disclosed for a porous plug that functions as an electro-osmotic pump. The polymer eliminates any back pressure effects while enhancing the electro-osmotic flow in a channel. The pump is bach fabricated by surface micromachining on top of a silicon wafer. The pump device is driven by an alternating zero-average injected current signal at low frequencies producing a bubble-free electro-osmotic flow with a reversible net movement. The device is capable of an average water-air interface velocity of 1.8 μm/second at 0.8 Hz. The velocity may be increased from between 4.8-13.9 μm/second by necking down the channel size.

### STATEMENT OF GOVERNMENT RESEARCH SUPPORT

The U.S. government has a paid-up license in this invention and the right in limited circumstances to require the patent owner to license others on reasonable terms as provided for by the terms of grant number F30602-00-1-0571 awarded by DARPA.

### FIELD OF INVENTION

This invention relates to the field of porous polymers, specifically porous polymers that are electro-osmotic, and even more specifically electro-osmotic porous polymers that provide electrokinesis to dielectric fluids.

### BACKGROUND

Fully integrated microfluidic systems are highly effective because complete automation reduces the consumption of organic or chemical reagents significantly. (Schasfoort et al., “Field-effect flow control for microfabricated fluidic networks.” Science, 286, 942-945 (1999)) Integrated microfluidic systems, however, require pumps and valves that precisely control the liquid flow from one part of the system to another. Complex microfluidic systems require many independently operating pumps and valves operated simultaneously or sequentially. Therefore, pumps and valves in a microfluidic system must be easy to fabricate and integrate with the other components of the system. (Carlen, E. T. et al., “Paraffin actuated surface micromachined valves.” MEMS 2000, 381-385 (2000))

The present state of microfluidic system art shows a preference for two types of pumps, mechanical and non-mechanical. Mechanical pumps operate by the movement of membranes actuated pneumatically, thermo-pneumatically, piezoelectrically and electromagnetically. These moving parts consequently make them poor choices for integrated systems even though these pumps are compatible with any liquid. Lemoff A. V., et al., “An AC magnetohydrodynamic micropump towards a true integrated microfluidic system.” Sensors and Actuators B: Chemical, 63, 178-185 (2000)) Non-mechanical pumps (i.e., electrokinetic), on the other hand, have no moving parts thus simplifying their fabrication and operation. Electrokinetic pumps typically consist of an electrode array spanning some distance within a channel. These pumps use an electrohydrodynamic effect to move dielectric liquids; usually the electrochemical generation of bubbles act as the driving force. (Shaw, D., “Electrophoresis” Academic Press (1969)) Additionally, the driving force for electrokinetic fluid flow result from the motion of charges induced either by electro-osmotic or electrophoretic effects. (Morf, W. E. et. al., “Partial electroosmotic pumping in complex capillary systems Part 1: Principles and general theoretical approach.” Sensors and Actuators: B,72, 266-272 (2001)) Electro-osmotic flow pumps (EOP) have received much attention for biological applications such as capillary electrophoresis systems because of easy fabrication, no moving parts and very little hydrodynamic dispersion when transporting fluid zones. (Manz A., et. al., “Electroosmotic pumping and electrophoretic separations for miniaturized chemical analysis systems.” J. Micromech. Microeng., 4, 257-265 (1994)) However, conventional EOPs have two main problems.

First, aqueous solutions subjected to electrode potentials larger than 1.1 V undergo electrolysis leading to bubble generation and eventual blockage of the fluid channel. The placement of electrodes at open areas (i.e. reservoirs) help eliminate channel blockage by allowing accumulated bubbles to escape the system. Normally, the distance between the EOP electrodes is large, so that significant flow velocities require very high voltages (i.e., 10-50 kV). This configuration does not accommodate the implementation of precise flow control electronics that require a much lower electrode voltage.

Second, standard EOP systems also induce fluid flow by the motion of charges in the double layer along the surface of the channel. However, this duality in charge motion creates a tendency to generate fluid counter flows (i.e. an upstream flow) driven by hydrostatic pressure gradients. (Shaw, D., supra) The art has identified this pressure flow resistance to be caused by a microchannel streaming potential. Most notably, pressure flow resistance reaches the highest levels when the channel dimensions are of the same scale as the double layer. Additionally, in EOPs having an open design, any flow resistance element placed in front of the EOP (i.e., on the upstream side) causes a pressure buildup and a significant counter flow that is highly significant in short channels.

EOPs that are currently available on the market, like the PCR systems (Cepheid, Handylab) and Electrophoresis systems (Caliper, Aclara) are simple systems consisting of “mixing and reaction” or “mixing and separation” stages. These systems are restricted in their complexity because of a lack in suitable valve and pump technology having the required precision and controllability in providing fluid flow rates.

Electrokinetic pumping, as currently practiced, suffers primarily from three important drawbacks that complicate implementation in large-scale integrated microfluidic systems; i) bubble generation at the electrodes; ii) high voltage required for generation of pressure flow, and iii) lack of effective valving to eliminate pressure back flow. What is necessary is a pump or valve that can precisely control hydrodynamic fluid flow in microfluidic systems without bubble formation that also reduces downstream flow resistance.

### SUMMARY OF THE INVENTION

A preferred embodiment of this invention provides a method that i) eliminates electrode-generated gas evolution by using a novel current signal application and ii) provides a porous polymer plug placed within an electrode pattern (e.g., between the electrodes) that creates a channel high flow resistance but, unlike previous EOPs, actually reduces, and may eliminate, the pressure driven counter flow. (Paul, P. H., et al., “Electrokinetic generation of high pressures using porous microstructures.” μTAS, 49-53 (1998); Yu, C. et al., “Towards Stationary Phases For Chromatography On A Microchip” Electrophoresis, 21, 120-127 (2000)). While it is not necessary to understand the mechanisms underlying an invention, it is speculated that the increased surface area of a porous polymer provides sufficient fluid holding capacity and an overall fluid flow enhancement so that a pressure-driven counterflow does not develop. Therefore, unlike systems practiced in the art, one embodiment of the porous polymeric material contemplated by this invention may eliminate pressure back flow when placed in a microfluidic channel. Hence, the use of a porous material, having pore sizes in the range of 1 nm to 1 μm (more preferably between 10 nm-100 nm), provides an enormous resistance to pressure flow without any counter flow, thereby resulting in precise downstream fluid flow control.

The above suggests that electro-osmotic flow is dependent upon surface area, and as such, a porous polymer actually enhances fluid flow. This relationship between polymer porosity and electrical potential permits an embodiment of this invention as a system involving short channels driven by electrical potentials generated by voltages as low as 20-30 V. Unlike previous attempts in the art when using voltages in excess of 1.1 V, this invention contemplates an embodiment that applies a zero net current (and zero net charge) alternating current signal across the electrode pattern at very low frequencies; this electrical field configuration minimizes, or eliminates, electrode-generated bubble formation. This bubble-free EOP technique (bf-EOP) thus allows the use of voltages much larger than 1.1 V. The direction and magnitude of the flow is determined by the polarity of the applied current, the width of the pulses and the nonlinear behavior of the electrode interface.

In one embodiment, vertical electrodes (i.e., measuring for example, 20 μm high, 10 μm wide pillars separated by a 10 μm gap) establish a uniform electric field at the active area of the pump. Additionally, this embodiment is able to increase the electrode surface area thereby making the device more immune to bubble generation for the same current amplitude since bubble generation is related to current density.

Alternatively, the fluid flow rate is increased if the alternating current is off-set by a second direct current source. This combination, without modification, leads of generation of bubbles. The problem of direct current off-set embodiment bubble generation is solved by protecting the electrodes with a layer of dielectric and prevents fluid contact.

Embodiments of the present invention have several advantages over the art, for example;

It is electrically controlled (i.e, precise electrical controllability of fluid flow rates).

The total volume of the valve and the pump is small (i.e., microfabrication allows novel applications).

It conforms to the shape of the channel (i.e., physically flexible).

It adds only a couple of steps to the current process flow hence is easy to implement (i.e., a simple design allows integration into existing systems).

It provide total control of the position of the fluid with elimination of the pressure component (i.e., no electrostatic backpressure gradients).

It is a normally closed state, hence energy is only required when the valve has to open and the liquid has to be moved (i.e., an electrical field is required only to move the fluid).

It has no moving parts.

It has very precise fluidic control.

It has a low power consumption.

It has a high integration density making it highly compatible with integrated microfluidic systems.

These exemplary advantages are ideally suited to allow integration into complex microfluidic systems that require the simultaneous and precise control of a series of valves and pumps. Specifically, one embodiment of this technology is contemplated for systems that require precise metering of liquid, exact positioning of liquid and low power operation; for example, but not limited to, microfluidic analytical systems such as nucleic acid hybridization, PCR, capillary electrophoresis, electrochromatography, DNA and/or protein sequencing, and DNA fingerprinting.

Other embodiments may be useful in pharmaceutical analysis and drug screening where a number of chemicals can be tested using parallel arrays. Still other embodiments are applicable to toxicological drug screening that require different arrays of specifically grown tissues. These tissue array systems are contemplated to include a network of channels, a multitude of pumps and a mixing of different chemical ratios to support parallel testing operations.

Additionally, clinical drug delivery and drug microdosing embodiments are contemplated that require control of precise minute quantities using a very low power. Miniaturization is an important aspect of developing clinically related pumping systems. Patient comfort and device reliability are expected to be achieved by designing medical devices having integrated microfluidic systems. A preferred embodiment of this invention contemplates a microfluidic system that is implantable under the human skin.

In a preferred embodiment this invention contemplates a composition, comprising a cast polymer comprising pores and a wafer adhered to said polymer. In an alternative embodiment this invention contemplates a composition comprising a) a cast polymer comprising pores, wherein said pores are of a size such that fluid can flow through said polymer, b) a wafer adhered to said polymer, and c) a metal mask defined on a top portion of said polymer, wherein the unmasked top portion of said polymer is etched.

In another embodiment this invention contemplates a method, comprising a) providing: i) a monomer solution; ii) a casting mold; iii) a heat source; iv) an adhesion promoter, and v) a wafer; b) coating said casting mold with said adhesion promoter to create a coated mold; c) pouring said monomer solution into said coated mold; e) placing said wafer on said monomer solution in said coated mold to create an enclosed mold; and f) heating said enclosed mold with said heat source until said monomer solution polymerizes, so as to create a porous polymer. In an alternative embodiment this invention contemplates a method, comprising a) providing: i) a monomer solution, wherein said solution comprises at least two monomers and a solvent; ii) a casting mold; iii) a heat source; iv) an adhesion promoter, and v) a wafer; b) coating said casting mold with said adhesion promoter to create a coated mold; c) pouring said monomer solution into said coated mold; d) enclosing said coated mold by placing said wafer on said monomer solution so as to create an enclosed mold; e) heating said enclosed mold with said heat source until said monomer solution polymerizes, so as to create a porous polymer; f) coating a portion of said porous polymer with a metal mask; and g) etching an unmasked portion of said porous polymer, thus forming a patterned porous polymer structure. It is not intended that this invention be limited by the monomer solution. Many different combinations of reactive monomers are contemplated in this invention. Preferably, these polymers may be made by reacting a monomer comprising a hydroxyl group with a second monomer containing an alkene group. Most preferably, for example, these chemicals include 1-propanol and buteniol.

In a further embodiment this invention contemplates a method, comprising: a) depositing an insulation layer onto a substrate; b) creating an electrode pattern on said insulation layer; and c) placing a porous polymer structure within said electrode pattern. In an alternative embodiment this invention contemplates a method, comprising: a) depositing an insulation layer onto said substrate; b) creating an electrode pattern on said insulation layer; c) placing a patterned porous polymer structure within said electrode pattern; d) layering a photoresist layer over said patterned porous polymer structure and said insulation layer, thus forming a patterned porous plug mask; f) removing said photoresist layer from a small section on top of the patterned porous plug mask; g) depositing a parylene-C layer over said patterned porous plug mask; h) etching said photoresist layer thus forming channel walls, electrode openings, escape hole, reservoir openings and channel exit openings, wherein a patterned porous plug electro-osmotic pump is formed.

In still another embodiment this invention contemplates an apparatus, comprising; a) a substrate having an insulation layer; b) an electrode pattern layered on said insulation layer; c) a porous plug contacting said electrode pattern, wherein said plug comprises pores of a size allowing fluid flow through said plug. In an alternative embodiment this invention contemplates an apparatus, comprising; a) a substrate having an insulation layer; b) an electrode pattern layered on said insulation layer; c) a patterned porous plug contacting said electrode pattern, wherein said plug comprises pores of a size allowing fluid flow through said plug; d) a channel wall attached to said porous plug and said insulation layer thereby defining an upstream portion and a downstream portion; e) a reservoir opening and escape hole in said upstream portion; and f) a channel exit hole in said downstream portion.

In yet still another embodiment of this invention contemplates a method, comprising: a) providing; i) an apparatus, comprising; a) a substrate having an insulation layer, b) an electrode pattern layered on said insulation layer, c) a porous plug contacting said electrode pattern, wherein said plug comprises pores of a size allowing fluid flow through said plug, d) a channel wall attached to said porous plug so as to define first and second sides of a channel, and e) a reservoir on said first side of said channel; ii) an alternating current power source having a frequency within the range of 0.1 and 10 Hz, wherein said alternating current power source is connected to said electrode pattern; and iii) a dielectric liquid; c) filling said reservoir with said dielectric liquid; and d) applying an electrical potential across said electrode pattern using said alternating current power source whereby at least some of said dielectric liquid flows through said porous plug to said second side of said channel. In an alternative embodiment this invention contemplates a method, comprising: a) providing; i) an apparatus, comprising; a) a substrate having an insulation layer, b) an electrode pattern layered onto said insulation layer, c) a patterned porous plug contacting said electrode pattern, wherein said plug has pores of a size allowing fluid flow from an upstream side to a downstream side, d) a channel wall attached to said patterned porous plug and said insulation layer defining an upstream portion and a downstream portion, e) a reservoir opening and escape hole in said upstream portion, and f) a channel exit hole in said downstream portion; ii) an alternating current power source having a frequency within the range of 0.1 and 10 Hz; iii) a dielectric liquid; b) connecting said alternating current power source to said electrode pattern; c) filling said upstream portion of said patterned porous plug with said dielectric liquid; and d) applying an electrical potential across said electrode pattern using said alternating current power source whereby said dielectric liquid flows through said patterned porous plug without the generation of bubbles.

Definitions

As used herein, the phrase “dielectric liquid” is intended to encompass any liquid comprising molecules having the ability to act as a capacitor thereby holding an electrical charge when exposed to an electrical potential.

As used herein, the term “electro-osmotic” is intended to encompass the movement of any liquid out of or through any porous material under the influence of an electrical potential.

As used herein, the term “electrokinetic” is intended to encompass the movement of any liquid driven by an electrical potential.

As used herein, the term “bubble-free” is intended to encompass the ability to operate an electro-osmotic, electrokinetic liquid pump in the absence of substantial gas generation. Of course, while complete elimination of bubbles is desirable it is contemplated that reduced bubble formation is within the meaning of bubble-free (e.g., no visible bubbles).

As used herein, the phrase “cast polymer” is intended to encompass the use of a “casting mold” in the polymerization process that creates a polymer having a predetermined shape. This predetermined shape may result from spatial compatibility considerations with any electrode pattern.

As used herein, the term “pores” is intended to encompass any opening on the surface of a polymer having a size ranging from 1 μm to 1 nm (more preferably from 10 μm to 10 nm) permitting passage of a liquid from one side of the polymer to the opposite side of the polymer.

As used herein, the term “adjustable sizes” is intended to relate to controlled porosity during the porous polymer polymerization process. A uniform pore size is predetermined by selecting a specific relative percentage of the polymerizing monomer composition. Preferably, these monomers include 1-propanol and buteniol.

As used herein, the term “porous polymer” is intended to encompass any polymer containing pores that allows passage of fluids from one side of the polymer to the opposite side of the polymer.

As used herein, the phrase “controlled fluid flow” is intended to encompass the ability to precisely alter the electrical potential across any electrode pattern that predictably changes (i.e., increase or decrease) the movement rate of any dielectric fluid.

As used herein, the term “wafer” is intended to encompass any etchable material for the conduct of any electrochemical process. Most preferably, these materials include silicon, glass and quartz.

As used herein, the term “mask” is intended to encompass any opaque material used to shield selected areas of any surface for any deposition or etching process. Most preferably, these materials are formed of metal and photoresist.

As used herein, the term “unmasked” is intended to encompass that portion of any surface not covered by a masking material when other portions of the same surface are masked.

As used herein, the term “etched” is intended to encompass any process by which holes, channel or grooves are formed on any surface. Most preferably, these processes include photolithography, plasma oxygen, and hydrofluoric acid wet-etching.

As used herein, the term “plasma” is intended to encompass any etching composition involving a mixture of electrically charged and neutral particles, including electrons, atoms, ions, and free radicals. Plasma conducts electricity and reacts collectively to electromagnetic forces. Most preferably, the plasma composition comprises oxygen.

As used herein, the term “photolithographic” is intended to encompass any process involving the production of a solid state integrated component by repetitive layering and selective etching using a light pattern as a guide.

As used herein, the phrase “monomer solution” means a solution comprising one or more monomers (i.e., single units that serve as building blocks for a polymer) In one embodiment, it is intended to encompass a mixture of at least two distinct chemicals in a solvent when, upon heating, the chemicals polymerize into a porous polymer. It is not intended that this invention be limited by the monomer solution. Many different combinations of reactive monomers are contemplated in this invention, including those that polymerize in the presence of oxygen. In one preferred embodiment, these polymers may be made by reacting a monomer comprising a hydroxyl group with a second monomer containing an alkene group. In a more preferred embodiment, for example, these chemicals include 1-propanol and buteniol.

As used herein, the term “adhesion promoter” is intended to encompass any compound that facilitates permanent contact between the porous polymer and the substrate or parylene film. Most preferably, this adhesion promoter includes a 10:10:1 mixture of De-ionized H₂O:isopropyl alcohol:gamma-methacryloxytropyl trimethoxy saline (A174).

As used herein, the phrase “porous polymer structure” is intended to encompass a structure of any shape that permits fluid flow from one side of the structure through the structure to the opposite side.

As used herein, the phrase “patterned porous polymer structure” is intended to encompass any composition having etching, channels or the like. For example, these etchings or channels may be formed on wafers (e.g., silicon, glass, quartz, plastic etc) by processes involving masks (i.e., metal or photoresist) and possibly incorporating the common practices of photolithography utilizing plasma or acid exposures.

As used herein, the term “plug” is intended to encompass any porous polymer structure. Ideally, the plug is configured to fit into a channel (more specifically a microchannel) and is compatible with an electrode pattern.

As used herein, the term “channels” are pathways through a medium (e.g., silicon) that allow for movement of liquids and gasses. Channels thus can connect other components, i.e., keep components “in liquid communication.” “Microdroplet transport channels” are channels configured (in microns) so as to accommodate “microdroplets.” While it is not intended that the present invention be limited by precise dimensions of the channels or precise volumes for microdroplets, illustrative ranges for channels and microdroplets are as follows: the channels can be between 0.35 and 50 μm in depth (preferably 20 μm) and between 50 and 1000 μm in width (preferably 500 μm), and the volume of the microdroplets can range (calculated from their lengths) between approximately one (1) and (100) nanoliters (more typically between ten and fifty).

As used herein, the term “substrate” is intended to encompass any material to which an insulation layer may be placed thus allowing any deposition and etching process. Most preferably, this material comprises silicon, glass or quartz. In one embodiment, the substrate comprises a plastic.

As used herein, the phrase “electrode pattern” is intended to encompass the positioning of any electroconductive material (e.g., a metal) on an insulation layer such that it generates an electrical potential. In a preferred embodiment, it is patterned around a porous polymer structure. Most preferably, this material is gold.

As used herein, the phrase “insulation layer” is intended to encompass any non-conductive material capable of adherence to any substrate or photoresist. Further, the insulation layer may be resistant to specific types of etching processes. Most preferably, this material is parylene-C.

As used herein, the term “photoresist layer” is intended to encompass any photosensitive resin that loses its resistance to any etching process when exposed to radiation of a selected wavelength.

As used herein, the phrase “escape hole” is intended to encompass any opening in the channel wall on the reservoir side of the porus plug electro-osmotic pump that allows the escape of gas out of the fluidic system.

As used herein, the phrase “porous plug electro-osmotic pump” is intended to encompass any porous polymer structure when functioning to pass dielectric fluid from one side of a structure (such as a channel or microchannel) to the opposite side.

As used herein, the term “upstream” is intended to encompass any side of the porus plug electro-osmotic pump that is normally fed by the reservoir. Upon reversal of the electrical field potential, however, the pump will return at least some of the dielectric fluid into the reservoir.

As used herein, the term “downstream” is intended to encompass any side of the porus plug electro-osmotic pump that normally feeds the channel exit. Upon reversal of the electrical field potential, however, the pump will withdraw dielectric fluid from the channel exit.

As used herein, the phrase “channel exit hole” is intended to encompass any opening in the channel wall that delivers the dielectric fluid into remote areas of the fluidic system.

As used herein, the phrase “necked down” is intended to encompass any reduction in channel or microchannel size. In a preferred embodiment, a necked down channel increases the fluid flow rate due to the reduced size.

“Biological reactions” means reactions involving biomolecules such as enzymes (e.g., polymerases, nucleases, etc.) and nucleic acids (both RNA and DNA). Biological samples are those containing biomolecules, such proteins, lipids, nucleic acids. The sample may be from a microorganism (e.g., bacterial culture) or from an animal, including humans (e.g. blood, urine, etc.). Alternatively, the sample may have been subject to purification (e.g. extraction) or other treatment. Biological reactions require some degree of biocompatibility with the device. That is to say, the reactions ideally should not be substantially inhibited by the characteristics or nature of the device components.

“Chemical reactions” means reactions involving chemical reactants, such as inorganic compounds.

“Channels” are pathways through a medium (e.g., silicon) that allow for movement of liquids and gasses. Channels thus can connect other components, i.e., keep components “in liquid communication.” “Microdroplet transport channels” are channels configured (in microns) so as to accommodate “microdroplets.” While it is not intended that the present invention be limited by precise dimensions of the channels or precise volumes for microdroplets, illustrative ranges for channels and microdroplets are as follows: the channels can be between 0.35 and 50 μm in depth (preferably 20 μm) and between 50 and 1000 μm in width (preferably 500 μm), and the volume of the microdroplets can range (calculated from their lengths) between approximately one (1) and (100) nanoliters (more typically between ten and fifty).

“Conveying” means “causing to be moved through” as in the case where a microdroplet is conveyed through a transport channel to a particular point, such as a reaction region. Conveying can be accomplished via flow-directing means.

“Flow-directing means” is any means by which movement of a microdroplet or fluid in a particular direction is achieved. A preferred directing means employs a surface-tension-gradient mechanism in which discrete droplets are differentially heated and propelled through etched channels.

“Hydrophilicity-enhancing compounds” are those compounds or preparations that enhance the hydrophilicity of a component, such as the hydrophilicity of a transport channel. The definition is functional, rather than structural. For example, Rain-X™ anti-fog is a commercially available reagent containing glycols and siloxanes in ethyl alcohol. However, the fact that it renders a glass or silicon surface more hydrophilic is more important than the reagent's particular formula.

“Initiating a reaction” means causing a reaction to take place. Reactions can be initiated by any means (e.g., heat, wavelengths of light, addition of a catalyst, etc.)

“Liquid barrier” or “moisture barrier” is any structure or treatment process on existing structures that prevents short circuits and/or damage to electronic elements (e.g., prevents the destruction of the aluminum heating elements). In one embodiment of the present invention, the liquid barrier comprises a first silicon oxide layer, a silicon nitride layer, and a second silicon oxide layer.

“Merging” is distinct from “mixing.” When a first and second microdroplet is merged to create a merged microdroplet, the liquid may or may not be mixed. Moreover, the degree of mixing in a merged microdroplet can be enhanced by a variety of techniques contemplated by the present invention, including by not limited to reversing the flow direction of the merged microdroplet.

“Nucleic Acid Amplification” involves increasing the concentration of nucleic acid, and in particular, the concentration of a particular piece of nucleic acid. A preferred technique is known as the “polymerase chain reaction.” Mullis, et al., U.S. Pat. Nos. 4,683,195 and 4,683,202, hereby incorporated by reference, describe a method for increasing the concentration of a segment of target sequence in a mixture of genomic DNA without cloning or purification. This process for amplifying the target sequence consists of introducing a molar excess of two oligonucleotide primers to the DNA mixture containing the desired target sequence. The two primers are complementary to their respective strands of the double-stranded sequence. The mixture is denatured and then allowed to hybridize. Following hybridization, the primers are extended with polymerase so as to form complementary strands. The steps of denaturation, hybridization, and polymerase extension can be repeated as often as needed to obtain are relatively high concentration of a segment of the desired target sequence. The length of the segment of the desired target sequence is determined by the relative positions of the primers with respect to each other, and therefore, this length is a controllable parameter. By virtue of the repeating aspect of the process, the method is referred to by the inventors as the “Polymerase Chain Reaction” (hereinafter PCR). Because the desired segment of the target sequence become the dominant sequences (in terms of concentration) in the mixture, they are said to be “PCR-amplified.”

As used herein, the term “planar electrode pair” means any configuration of electrically conductive material placed in a horizontal position such that an electrical field is generated between each respective pair member.

As used herein, the term “vertical electrode pair” means any configuration of electrically conductive material placed in a vertical position such that an electrical field is generated between each respective pair member.

### BRIEF DESCRIPTION OF THE FIGURES

FIG. 1. A diagrammatic illustration of an alternating waveform resulting in a net zero charge.

FIG. 2. Pore size distribution profiles of porous polymers having differing percentages of 1-propanol; Peak 1=80%; Peak 2=78%; Peak 3=76%; and Peak 4=74%.

FIG. 3. A representative scheme for an embodiment describing a method for casting the porous polymer.

FIG. 4. An example of an embodiment of a patterned porous plug using REI.

FIG. 5. An exemplary four step process flow incorporating four lithography patternings for the preparation of an embodiment generating planar electrodes of the porous plug electro-osmotic pump.

FIG. 6. A photograph of an example of an embodiment of the porous plug electro-osmotic pump.

FIG. 7. Time-lapse demonstration of water-air interface movement for one embodiment of a planar electrode device: (a) movement in the forward (i.e., downstream) direction; (b) movement in the reverse (i.e., upstream) direction.

FIG. 8. Exemplary data showing a time-course relationship using planar electrodes: Panel A: alternating current at low frequencies, and Panel B: the non-net zero voltage response.

FIG. 9. Exemplary data showing a comparison of the time course relationships using planar electrodes between a low frequency alternating current signal, the non-net zero voltage response and the subsequent motion of a suspended particle in a fluid.

FIG. 10. A representative relationship between the average velocity of the dielectric fluid flow across a porous plug electro-osmotic pump within a 200 μm channel as a function of alternating current frequency.

FIG. 11. An photograph of two modified embodiments; Panel A: showing the channel necked down from 200 μm to 50 μm; Panel B: showing the channel necked down from 200 μm to 20 μm.

FIG. 12. A representative relationship between the average velocity of the dielectric fluid flow across a porous plug electro-osmotic pump as a function of alternating current frequency with the channel necked down to either 50 μm or 20 μm.

FIG. 13. Selected embodiments of electrode configurations: (a) planar; (b) vertical (pillar); (c) equipotential and electric field lines from planar electrodes; (d) equipotential and electric field lines from vertical electrodes. Note: The units of plots (c) and (d) are normalized wherein 1 corresponds to 25 μm.

FIG. 14. Exemplary data showing simulation results of two-dimensional planar (solid line) and vertical (dotted line) electrodes. The first electrode is located at x=0. The gap between the electrodes is 50 μm. The applied voltage is 50 Volts. The distance y is measured from the substrate surface (i.e., 0 μm) to 20 μm.

FIG. 15. A schematic representation of one embodiment of a fabrication process generating vertical electrodes in a pp-EOP device.

FIG. 16. A top view of one embodiment of a fabricated vertical electrode pp-EOP device.

FIG. 17. One embodiment of an integrated data collection system to measure voltage response.

FIG. 18. One embodiment of an integrated data collection system to measure water-air interface flow velocities.

FIG. 19. Exemplary data set showing measured voltage responses of a vertical electrode device with a 130 μm wide plug and a 30% duty cycle current input with +350 and −150 amplitudes.

FIG. 20. Time-lapse demonstration of water-air interface movement for one embodiment of a vertical electrode device: (A) movement in the forward direction; (B) movement in the reverse direction.

FIG. 21. Exemplary data set showing the average water-air interface velocities as a function of frequency using a plug 130 μm wide.

FIG. 22. Exemplary data set showing the average water-air interface velocities using a plug 100 μm wide in response to step current signals with the same duty cycles at the same frequencies having amplitudes of (+280, −120) nA multiplied by 1, 2, 3 and 4.

FIG. 23. Exemplary data set showing the average water-air interface velocities using a plug 130 μm wide in response to different duty cycled step current signals at the same frequencies with the same amplitude, duration products.

FIG. 24. Exemplary data set showing the average water-air interface velocities of plugs having different widths, in response to the same current signal.

FIG. 25. A schematic representation of one embodiment of a bubble-free ppEOP device.

### DETAILED DESCRIPTION OF THE INVENTION

In a preferred embodiment of this invention it is contemplated that controlled electrokinetic fluid flow is unaccompanied by measurable bubble formation. By contrast, conventional EOP using aqueous solutions, gas bubbles are generated at the electrodes causing significant problems in maintaining fluid flow and severely constraining operational voltage ranges.

Flow resistance to pressure flow increases proportional to r⁻⁴, where r is the radius of the channel, while that of electrokinetic flow is not affected. The use of a micromachined porous polymer plug between the electrodes creates a high flow resistance reducing the pressure driven counterflow substantially while allowing electrokinetically generated flow. The surface area is enhanced, thereby allowing a closer placement of driving electrodes to drive same flow rates. The smaller electrode gap results in the ability to lower the drive voltages to as low as 20 Volts. Previously used porous structures were either built by packing silica beads (Philp et al., μTAS 1998 Conference, Banff, Canada) or in-situ polymerization of the plug inside microfluidic channels (Cong et al., Electrophoresis, 21:120-127(2000) neither of which utilize batch fabrication processes and, hence, are unsuitable for integrated systems.

The art teaches that the amount of gas generated at the electrodes is proportional to the amount of net charge transferred to the H⁺ ions in the solution. The H⁺ ion production results in a steady current thereby inducing fluid flow. The fluid flow velocity is therefore linear with the applied field potential and voltage. As a result, using systems taught by the art, in order to increase fluid flow the voltage must be increased. Concomitantly, this increase in voltage also increases bubble formation in the system that significantly interferes with fluid flow and volume delivery.

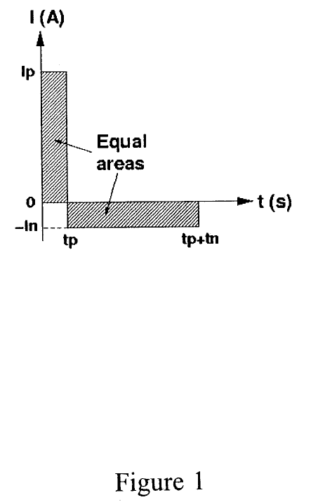

Although it is not necessary to precisely understand the mechanisms of an invention, it is believed that a contemplated bubble-free electro-osmotic pump is possible if the waveform of the applied electricalal potential has a zero net current. (see FIG. 1) It is further believed that any gas-producing electrochemical reactions occurring during a positive current phase are totally reversed during the subsequent negative current phase. Therefore, with a zero net current field potential, reactant gas molecules do not reach a concentration sufficient to form bubbles. In one embodiment of this invention, it is contemplated that this absence of bubble generation allows close polarity proximity within an electrode pattern thereby conferring an ability to generate a very high electrical field potential at low voltages.

It is well known in the art that two electrodes that generate an electricalal potential in an aqueous liquid have a linear current-voltage relationship under low voltages or high frequencies. Therefore, situations having a zero average current concomitantly results in a zero average voltage and no net fluid movement. At low frequencies, however, the field potential shows a non-linear current-voltage characteristic due to the activation control of the electrochemical cell. (Selvaganapathy P. et al., “Bubble Free Electrokinetic Pumping; (To be published); Bockris, J. O. M., et al., “Modern Electrochemistry”. Plenum Press (1973)). Specifically, this current-voltage asymmetry creates a net voltage signal on either the positive or negative phase of the alternating current cycle; depending on the polarity of the electrical potential. In low frequency alternating current applications, therefore, a zero-averaged current signal yields a non-zero averaged voltage and net motion of a dielectric fluid results.

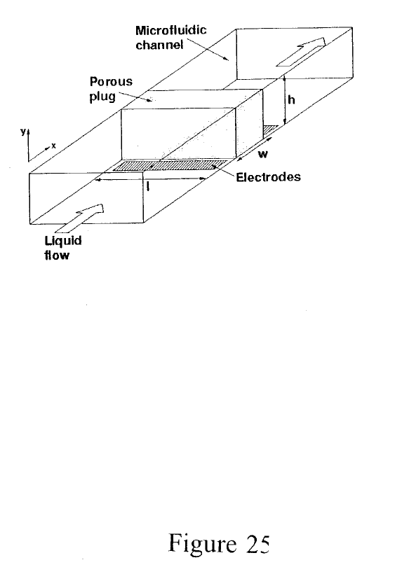

In one embodiment, a pp-EOP device comprises a microfluidic channel, electrodes and porous polymer plug. Preferably, the porous polymer plug does not require priming. For instance, once the liquid has been placed on one side of the plug, a pp-EOP will move the liquid-air interface to the other side of the channel and continue to pump the liquid while activated. FIG. 25 shows a schematic of one embodiment of a pp-EOP where the porous polymer plug is placed in the center of the microfluidic channel and on each side of the plug is an electrode. As a voltage is applied between the electrodes an electric field is formed acting on the walls of the pores of the porous polymer plug thus giving rise to electro-osmotic force (EOF). The operation of a pp-EOP device is controlled by, but not limited to, the pore size, the porous polymer plug width and the type, spacing and width of the electrodes.

### DESCRIPTION OF THE PREFERRED EMBODIMENTS

The present invention relates to the use of porous polymers in microfabricated microscale devices and reactions in microscale devices, and in particular, movement of biological samples in microdroplets through microchannels to initiate biological reactions. The present invention contemplates porous polymers in microscale devices, comprising microdroplet transport channels, reaction regions (e.g. chambers), electrophoresis modules, and radiation detectors. In a preferred embodiment, these elements are microfabricated from silicon and glass substrates. The various components are linked (i.e., in liquid or “fluidic” communication) using a surface-tension-gradient mechanism in which discrete droplets are differentially heated and propelled through etched channels. In another embodiment, the various components are in liquid communication by a continuous stream wherein the flow is regulated by valves and pumping. In yet another embodiment, the present invention contemplates the components of the present invention are in liquid communication by capillary action. In yet another embodiment, various electronic components (e.g., electrodes) are fabricated on the same support platform material, allowing sensors and controlling circuitry to be incorporated in the same device. Since all of the components are made using conventional photolithographic techniques, multi-component devices can be readily assembled into complex, integrated systems.

Electronic components are fabricated on the same substrate material, allowing sensors and controlling circuitry to be incorporated in the same device. Since all of the components are made using conventional photolithographic techniques, multi-component devices can be readily assembled into complex, integrated systems in conjunction with porous polymer electro-osmotic pumps.

It is not intended that the present invention be limited by the nature of the reactions carried out in the microscale device. Reactions include, but are not limited to, chemical and biological reactions. Biological reactions include, but are not limited to sequencing, restriction enzyme digests, RFLP, nucleic acid amplification, and gel electrophoresis. It is also not intended that the invention be limited by the particular purpose for carrying out the biological reactions. In one medical diagnostic application, it may be desirable to differentiate between a heterozygotic and homozygotic target and, in the latter case, specifying which homozygote is present. In another medical diagnostic application, it may be desirable to simply detect the presence or absence of specific allelic variants of pathogens in a clinical sample.

The present invention contemplates a method for moving microdroplets, comprising: (a) providing a liquid microdroplet disposed within a microdroplet transport channel etched in silicon, said channel in liquid communication with a reaction region via said transport channel and separated from a microdroplet flow-directing means by a liquid barrier; and (b) conveying said microdroplet in said transport channel to said reaction region via said microdroplet flow-directing means through a porous polymer. In another embodiment, it comprises porous polymers arranged either in parallel or series thereby allowing the simultaneous pumping of fluids in either single or multiple transport channels. Still further, this embodiment contemplates the porous polymer to deliver fluid to modules, such as an electrophoresis device.

It has been found empirically that the methods and devices of the present invention can be used with success when, prior to the conveying described above the transport channel (or channels) is treated with a hydrophilicity-enhancing compound.

It is not intended that the invention be limited by exactly when the treatment takes place. Indeed, there is some flexibility because of the long-life characteristics of some enhancing compounds.

Again, it has been found empirically that there is a need for a liquid barrier between the liquid in the channels and the electronics of the silicon chip. A preferred barrier comprises a first silicon oxide layer, a silicon nitride layer, and a second silicon oxide layer.

In silicon micromachining, a simple technique to form closed channels involves etching an open trough on the surface of a substrate and then bonding a second, unetched substrate over the open channel. There are a wide variety of isotropic and anisotropic etch reagents, either liquid or gaseous, that can produce channels with well-defined side walls and uniform etch depths. Since the paths of the channels are defined by the photo-process mask, the complexity of channel patterns on the device is virtually unlimited. Controlled etching can also produce sample entry holes that pass completely through the substrate, resulting in entry ports on the outside surface of the device connected to channel structures.

The present invention contemplates a two-part approach to construction of a preferred embodiment. Microchannels are made in the silicon substrate and the structure is bonded to a glass substrate. The two-part channel construction technique requires alignment and bonding processes but is amenable to a variety of substrates and channel profiles. In other words, for manufacturing purposes, the two-part approach allows for customizing one piece (i.e., the silicon with channels and reaction formats) and bonding with a standardized (non-customized) second piece, e.g., containing standard electrical pads.

Electrodes

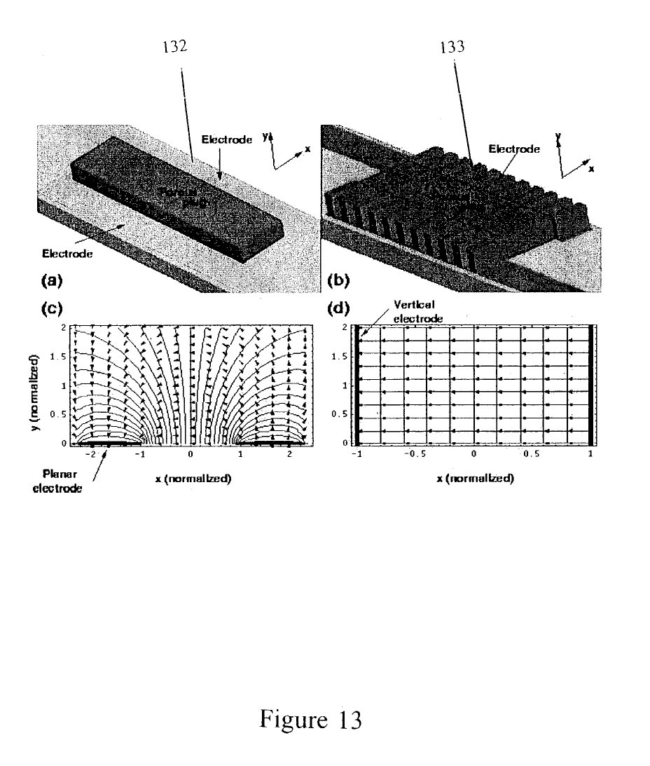

One aspect of the present invention contemplates a pp-EOP device comprising electrodes. In one embodiment, a planar electrode pair 132 is used on both sides of the porous polymer plug as shown in FIG. 13A. In another embodiment, a vertical electrode pair 133 is used as shown in FIG. 13B.

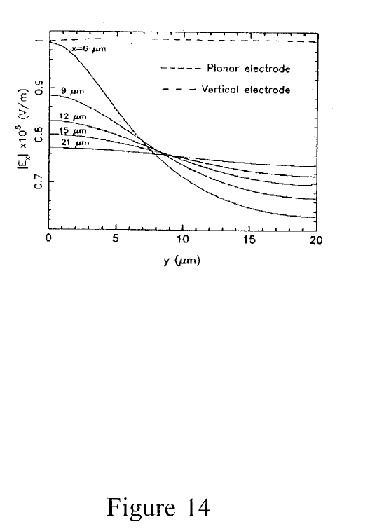

A vertical electrode pair 133 provides a nearly constant field profile in the x-direction for all values in the y-direction (i.e., the field profile is uniform across the width of a porous polymer plug). In addition, a vertical electrode pair 133 provides a much larger surface area than the planar electrode pair 132 and are capable of carrying larger currents prior to the intiation of bubble generation. One skilled in the art would understand the advantage of this, as larger currents result in higher voltages and consequently larger flow velocities. Furthermore, when using the same current amplitudes, vertical electrode pair 133 has much better resistance to bubble generation and is therefore more stable. The electrical field potential, φ, for the planar electrode pair 132 is calculated by conformal mapping using the Schwartz-Christoffel transformation (Saff et al., Fundamentals Of Complex Analysis For Mathematics, Science and Engineering, Prentice-Hall, Inc. (1993). The electrical field potential is defined as φ(x,y)=V/2(1−K(k)⁻¹Re{sn⁻¹(z,k)}, where V is the applied voltage, K(k) is the complete elliptic integral of the first kind, z=x+iy, sn⁻( ) is the inverse Jacobi elliptical integral, and k is the modulus. The electric field is E=−δφ/δx, where δ is the complex conjugate. The equipotential and field potential lines are shown in FIGS. 13(c) and (d) for both electrode configurations. FIG. 14 shows the magnitude of the electric field (E) for both electrode configurations using; i) an electrode gap space of 50 μm (w), ii) an electrode width of 30 μm (s), and iii) a porous polymer plug+vertical electrode height of 20 μm (h), and voltage difference between the electrodes of ΔV=50 Volts. From FIG. 14, the magnitude of the electric field for the vertical electrode pair 133 is seen to be a constant Eₓ=50 Volts/50 μm=10⁶ V/m for all values of x. The field magnitude for the planar electrode pair 132 decreases while moving to the top of the channel, hence increasing the y distance. The average electric filed magnitude for the planar electrode pair 132 shown in FIG. 14 is 0.75×10⁶ V/m.

Consequently, the surface area exposed to the fluid is increased with a vertical electrode configuration. Using the dimensions of planar electrodes (supra), the exposed surface area of a single planar electrode is; Aₚ=(200)(30) μm²=6000 μm². On the other hand, a vertical electrode configuration having 9 pillars, wherein each pillar is 20 μm tall and 10 μm wide, the total exposed surface area for a single electrode is Aᵥ=204,000 μm².

Experimental

The following are non-limiting examples of this technology. It is not intended that this disclosure is limited to these representations. One of skill in the art would easily recognize that many different variations on the compositions and methods described below are within the intended scope of this disclosure.

The fabrication development of the pp-EOP device may be, but is not limited to, the performance of two steps. The first step comprises technology to spin-cast and pattern the porous polymer plug material. The second step comprises an integration of any existing surface micromachined process technology. Man P. E., PhD Thesis, Monolithic Structures For Integrated Microfluidic Assays, University Of Michigan, Ann Arbor (2001); Webster, Monolithic Structures For Capillary Electrophoresis Systems, University Of Michigan, Ann Arbor (1999). The final pp-EOP devices are fabricated using low temperature surface micromachining technology. For example, the planar electrode devices may use a four step lithography mask process and the vertical electrode fabrication preferably follows a five step lithography process.

### EXAMPLE 1

### Preparation of the Porous Polymer

In one embodiment, a new novel porous polymer, poly(butyl methacrylate-co-ethylene dimethacrylate-co-2-acrylamido-2-methyl-1-propanesulfonic acid), is preferred. The porous material is formed by casting of a porogenic monomer solution inside a predetermined mold casting. The monomer solution was prepared by mixing 0.8 g ethylene dimethacrylate (EDMA), 1.18 g butyl methacrylate (BMA), 20 mg azobisisobutyronitrile (AIBN), 2.214 g 1-propanol and 0.486 g 1,4-butanediol (Sigma-Aldrich, Corporation). The mold casting shape and size is determined by an assessment of the configuration of the electrode pattern required for the proper operation of the electro-osmotic process.

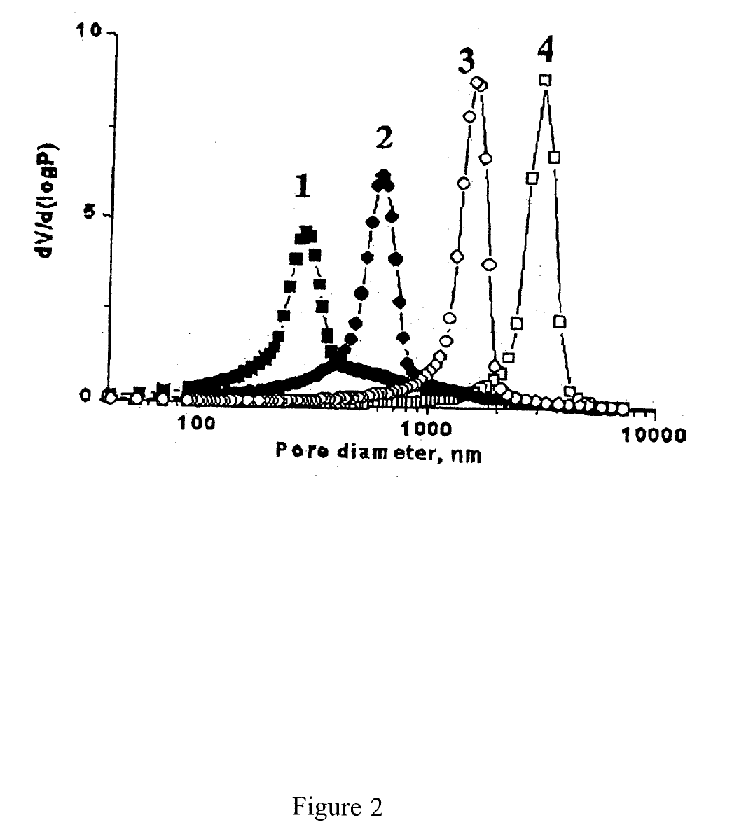

The preparation of the porogenic solution is as described in Yu et al., (supra). The porosity of this porous polymer can be adjusted easily between the range of one (1) nm to one hundred (100) μm by changing the percentages of 1-propanol and buteniol in the porogenic solvent of the monomer solution. (see FIG. 2) A surprising property of the porous material is that the surface charge density of the pore walls, or zeta potential, is easily controlled by adding different percentages of aqueous 2-acrylamide-2-methyl-1-propanesulfonic acid (Sigma-Aldrich, Corporation) dissolved in water. Eric et al., Anal. Chem. 70:2288-2295 (1995).

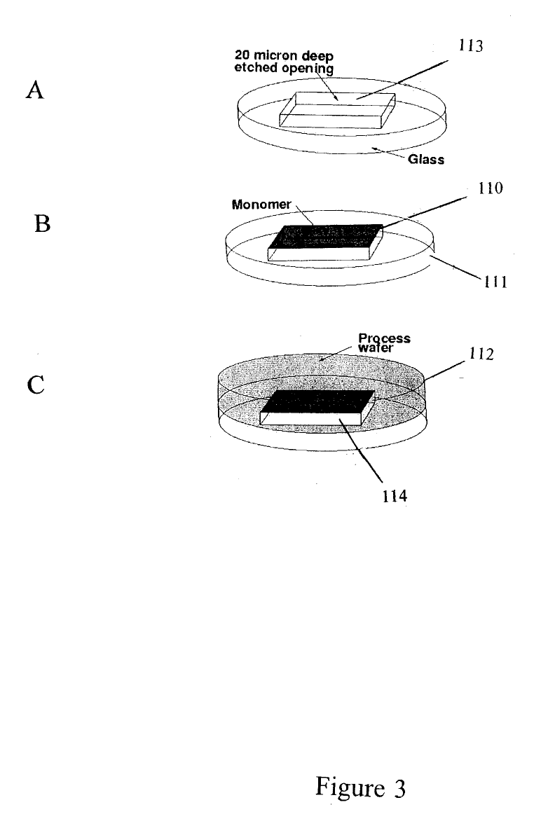

Initial attempts to cast the polymer failed because of the low viscosity and an inability to polymerize in the presence of oxygen. These difficulties were solved by enclosing the porogenic monomer solution 110 between a silicon substrate 111 and a glass wafer 112 creating a 20 μm deep etched well casting mold 113 (FIG. 3: Panels A-C). Subsequently, the glass wafer was wet-etched in HF:HNO₃:H₂O (7:3:10) with a Cr/Au (20/100 nm) mask. The cavity etched in the glass wafer is the mold for the low viscosity monomer. The cavity, or mold, was then filled with a monomer solution. The process wafer, typically oxidized silicon, was then placed in contact with the glass wafer and the monomer solution. The solution was trapped between two wafers and polymerized by either heating on a hotplate at 55° C. for an extended period of time (i.e., for example, 10 hours or more) or by induced by ultraviolet irradiation.

An adhesion promoter having a 10:10:1 ratio of the composition of de-ionized water:isopropyl alcohol:γ-methacryloxytropyl trimethoxy saline (A174, Specialty Coating Systems, Inc.) was applied under a low pressure (e.g., 0.1-10 mTorr) before pouring the porogenic monomer solution 110 onto the silicon substrate 111. This coating ensures the proper adhesion of the porous polymer 114 to the silicon substrate 111; and also to later applied parylene-C films. When contemplating parylene-C and oxide coated substrates, exposing the surface to oxygen plasma for at least 1 minute at low power increases the effectiveness of the adhesion promotor.

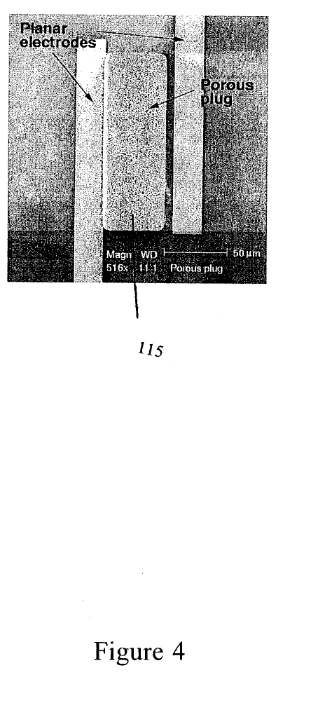

The enclosed porogenic monomer solution was then polymerized in the casting mold 113 by heating on a hotplate at 55° C. overnight. The top of the resulting porous polymer film was patterned using a Cr—Al metal mask created by a lift-off process. The unmasked polymer areas were plasma etched inside a Semi-group Inc. REI at an approximate rate of 1 μm/min in a mixture of 47.5 sccm O₂ and 2.5 sccm CF₄ at 50 mTorr and 150-watt RF power. A completed patterned porous polymer structure 115 is shown in FIG. 4.

It is preferred to use REI for etching patterning but photodefinition of the porous polymer with 365 nm UV light is also possible. This requires, however, a 10 hour light exposure having a 1150 μW/cm² intensity. During this period, the polymer requires cooling to prevent additional polymerization that would result in a low resolution pattern (i.e., ˜50 μm). A contact aligner might improve the resolution, but would require extensive modification.

The final fabrication of the pp-EOPs integrates a porous polymer plug, as herein described in Example 1, with any existing surface micromachined process technology. The present invention, however, is more clearly exemplified by describing two different fabrication processes that result in two difference electrode structures. First, the fabrication of the planar electrode devices is presented. Second, the fabrication of the vertical electrode devices is presented that utilizes an additional lithography step and a nickel electroplating step to form the tall, vertical electrodes.

### EXAMPLE 2

### Porous Polymer Electro-Osmotic Pump: Planar Electrodes

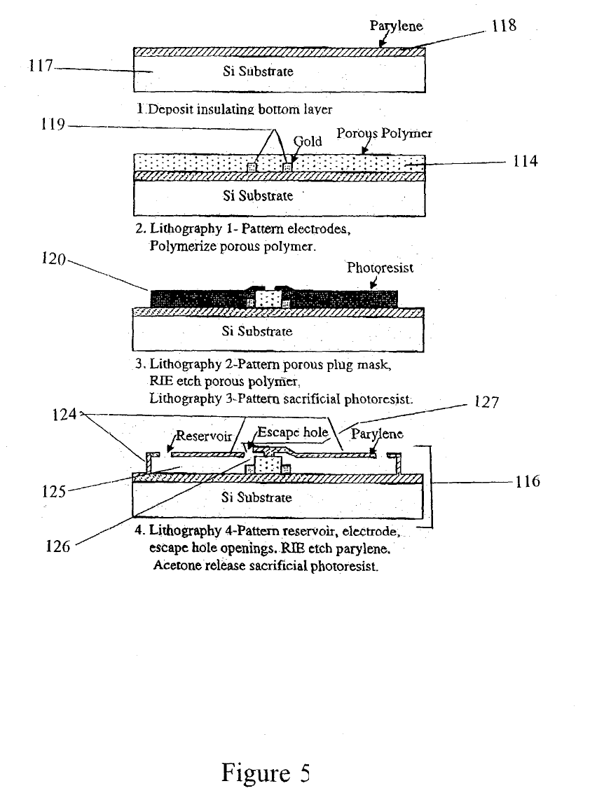

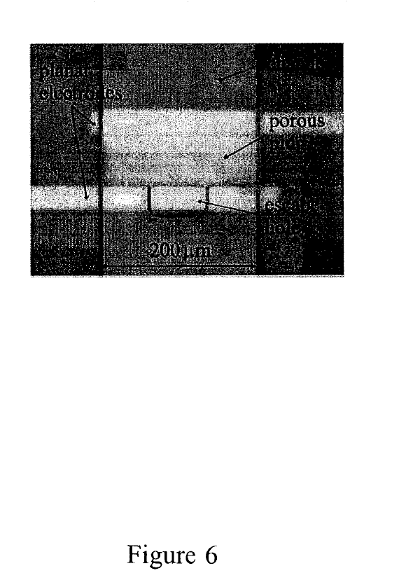

An exemplary four (4) step preparation process of an embodiment of a porous polymer electro-osmotic pump (pp-EOP) 116 was used that incorporates four (4) lithography steps. (see FIG. 5) Preferably, silicon was used as a starting substrate 117, but it can be any other material that is compatible with the process (i.e., glass or quartz). In step 1, a 5 μm thick parylene-C layer 118 was deposited to function as an electrode insulator. Additionally, the parylene-C formed the bottom layer of the channel. Optionally, a 1 μm thick thermal oxide can also be used as an insulator and bottom layer. In step 2, a 200 μm layer of Au was electron-beam evaporated and configured to form an electrode pattern 119 (Lithography 1). In step 3, a patterned porous polymer 115 (i.e., a plug) was prepared according to Example 1 and placed within the electrode pattern 119 (Lithography 2). A layer of photoresist 120 (20 μm-thick) was then deposited as a sacrificial layer, carefully keeping clear a small patterned section on the top of the patterned porous polymer plug 115 (Lithography 3). In step 4, parylene-C (4 μm-thick) was layered on the photoresist 120 to allow formation of the channel walls 124 using oxygen plasma etching in a Semi-group REI (40 minute duration; 100 sccm O₂, 200 mTorr, 150 watt RF). This oxygen plasma etching step also defined the opening to reservoir 125, electrode openings 126 and a 30×60 μm³ escape hole 127 (allows the removal of the entrapped air during the etching process, thereby reducing etching duration, or during subsequent testing). Lastly, the remaining sacrificial photoresist under the channel walls 124 was removed using acetone (Lithography 4). A photograph of one completed embodiment is depicted in FIG. 6.

### EXAMPLE 3

### Porous Polymer Electro-Osmotic Pump: Vertical Electrodes

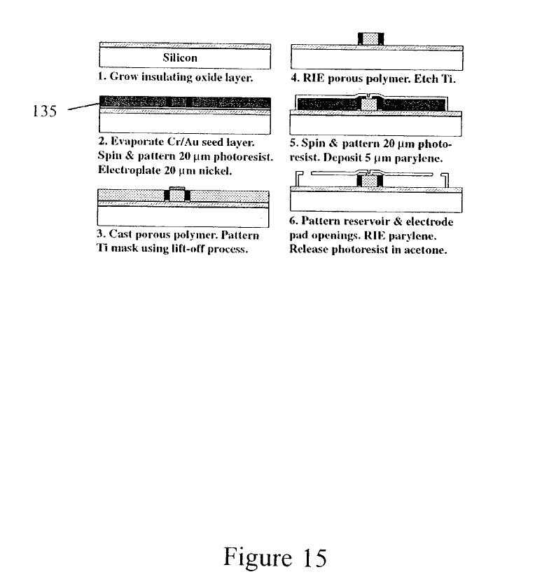

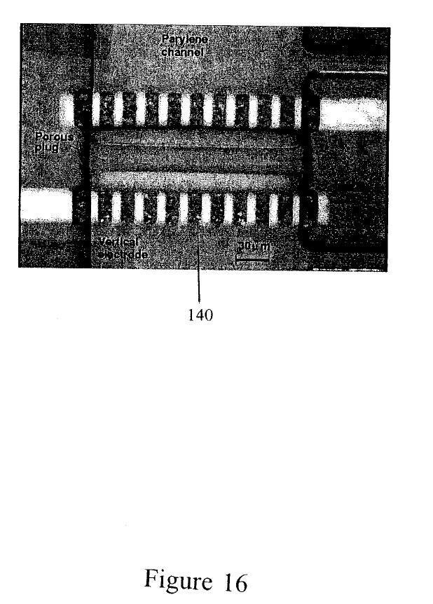

The fabrication process to create a vertical electrode device using silicon substrates begins by growing a 2 μm thick oxide isolation layer for the electrodes followed by an electron-beam evaporated Cr/Au (30/500 nm) electroplating seed layer. The gold (Au) layer was next patterned and etched. Subsequently, a 20 μm thick photoresist electroplating mold was patterned to provide for the pillar openings. A 20 μm thick nickel (Ni) layer 135 was then electroplated on the exposed gold layer (Sulfamate, MacDermaid, Inc). Following the nickel electroplating step, the photoresist mold and Cr adhesion layers are removed. The 20 μm thick porous plug (fabricated according to Example 1) is placed between the electrodes. Next, a 20 μm thick layer of photoresist is patterned thereby forming a sacrificial layer to form the microfluidic channels and reservoirs. However, some resist is removed only from a small section on the top of the plug. A 5 μm thick layer of parylene is then vacuum deposited to form the walls of the channels. Next, a 20 μm-thick photoresist layer is used as a mask to etch the reservoir and contact pad holes in the parylene using an O₂ plasma. The residual sacrificial photoresist is released in an acetone soak. FIG. 15 shows a simplified process flow for fabricating the vertical electrode pp-EOP device. FIG. 16 shows a microscope photograph of a fabricated vertical electrode pp-EOP 140.

### EXAMPLE 4

### Using the Porous Plug Electro-Osmotic Pump

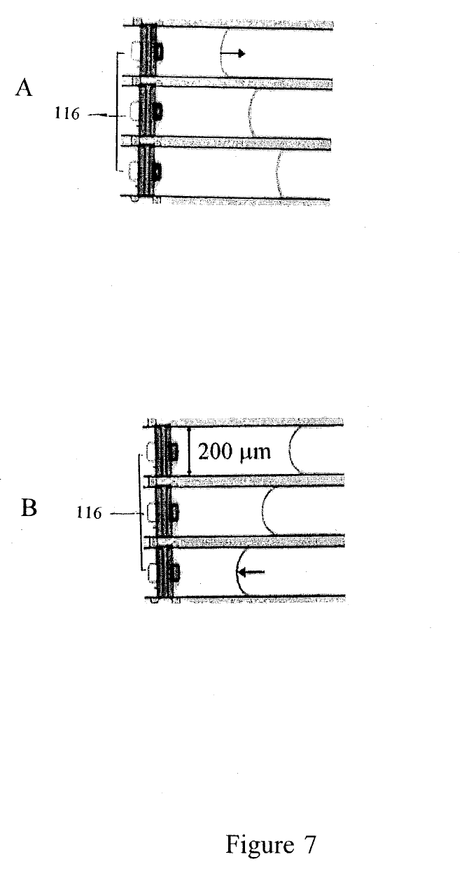

A 300 nm pore size pp-EOP device was prepared as described in Example 2 using 80% 1-propanol. Devices with both planar and vertical electrodes have been tested. The composition was tested for electro-osmotic properties using de-ionized water (DI). To begin the pump operation, the reservoir on the upstream side of a planar pp-EOP 116 was filled with DI, the water wicked between the channel walls 124 and stopped alongside a planar pp-EOP 116. To initiate the fluid flow, an alternating low frequency zero-averaged current signal was applied to the electrode pattern 119. Application of this particular electrical field potential resulted in a slow movement of DI from the upstream side to the downstream side of a planar pp-EOP 116. (See FIG. 7, Panel A) Reversing the electrical field potential resulted in the opposite DI water flow direction, i.e., from the downstream side to the upstream side of a planar pp-EOP 116. (See FIG. 7, Panel B). The net direction of the flow is generated by the duty cycle and the nonlinear behavior of the electrode interface.

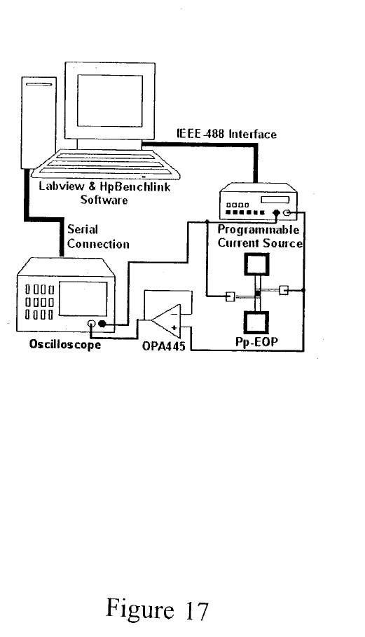

The generated voltage across the ppEOP electrodes due to an injected current is complex, comprising both resistive and capacitive phenomenon. Voltage responses may be measured by systems using an interface circuit and oscilloscope (Hewlett Packard, Inc. HP54645A) as shown, for example, in FIG. 17. An interface circuit uses an operational amplifier (Burr-Brown, Inc., OPA445) connected as a voltage follower thus matching the impedance of the pp-EOP device (i.e., approximately 30 Megaohms). Selvaganapathy et al., J. Microelectromech Syst, 11:1-6 (2002). In these experiments, the periodic current signal was applied to the electrodes and the resulting voltage response measured with the oscilloscope and recorded with a computer.

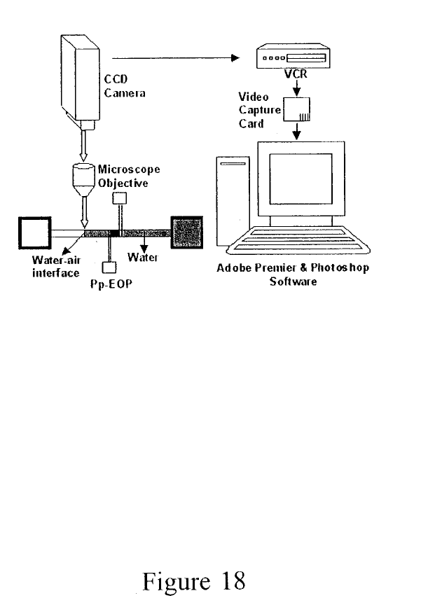

As shown in FIG. 18, flow velocity was also measured for devices comprising either planar 132 or vertical 133 electrode embodiments. Water-air interface movements in response to applied signals were recorded using a color charged-coupled device (CCD) camera (Topica TP-8002A) attached to a microscope. The interface movements were digitized with a video capture hardware (30 frames/sec) and analyzed using a commercial software package (i.e., for example, Adobe Premier).

Planar Electrode Measurements.

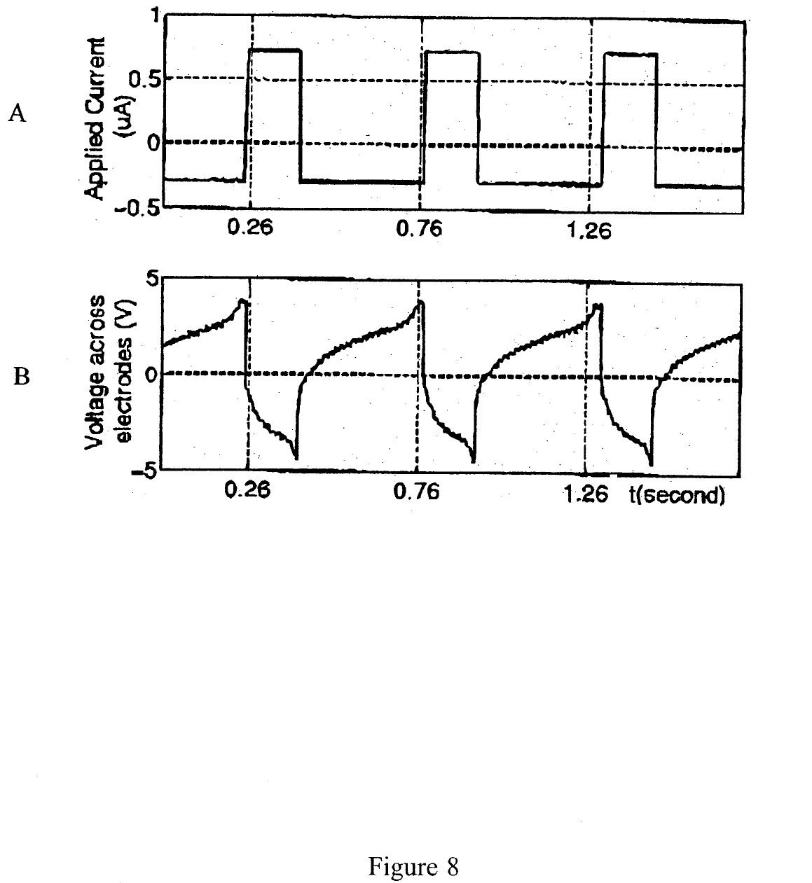

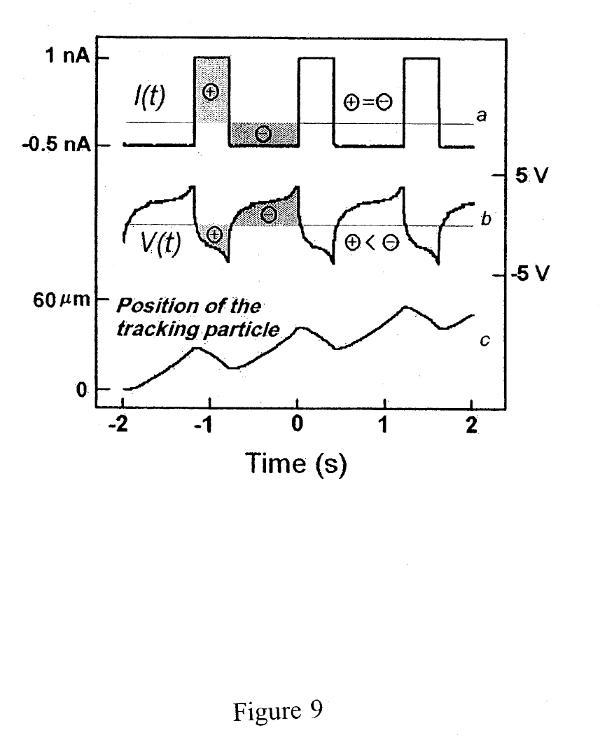

One embodiment of this invention contemplates an alternating zero-averaged current signal at a signal frequency of 2 Hz and 30% duty cycle step current signal with +700, −300 nA amplitudes at different frequencies was applied to the cell and the de-ionized water-air interface movement velocity was recorded. The response is non-linear with non-zero average as predicted by bubble-free EOF technology that produces a non-zero net fluid motion. (see FIG. 8, Panel A) The corresponding voltage response is non-linear, as shown by the greater area under the curve for positive voltage induction versus the negative voltage induction. (FIG. 8, Panel B) This results in a non-zero voltage average thereby inducing fluid motion. A side-by-side comparison of alternating low frequency current, voltage induction response and resulting movement is depicted in FIG. 9. Again, the current-voltage asymmetry is clearly seen in that the positive voltage waveform is larger than the negative voltage waveform. Therefore, the difference between the positive and negative waveform integrals result in the non-zero averaged voltage and is responsible for fluid flow. As demonstrated above, the direction of this non-zero net fluid motion is reversible when the time averaged voltage response changes sign. This directionality change is achieved simply by reversing the injected current signal.

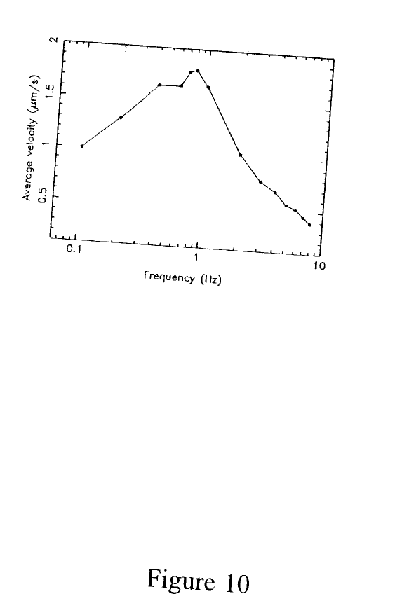

Fluid flow velocity induced by a non-zero net voltage average is primarily a function of the injected current frequency. An exemplary frequency-velocity response curve of a sample water-air interface is shown in FIG. 10. A 1.8 μm/sec maximum velocity was apparently reached at 0.8 Hz with an electrical field potential of ˜200 V/cm within a 200 μm channel.

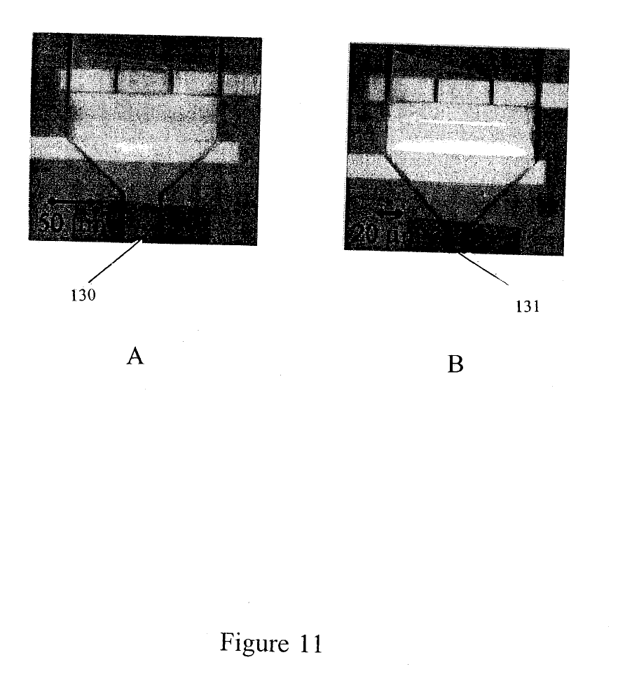

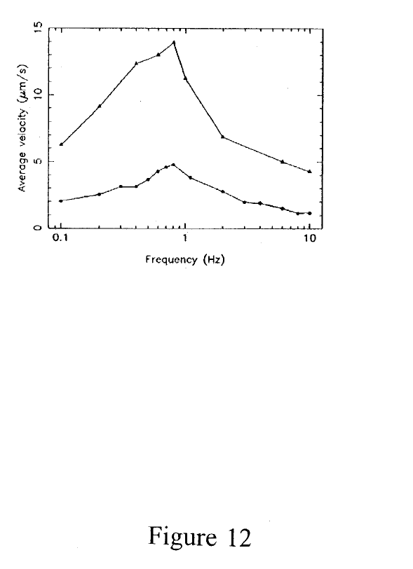

This maximal fluid flow rate is primarily responsible for the precise pumping ability of a planar pp-EOP 116. In one embodiment, however, it is contemplated that faster motion is achieved simply by necking down (i.e., reducing) the channel dimensions. Representative regular channels (200 μm) were necked down at a 45° angle to both 50 μm 130 and 20 μm 131 (see FIG. 11, Panel A and B, respectively). This modification resulted in significant increases in fluid flow rates. For example, the 50 μm channel embodiment increased to a maximum velocity of 4.8 μm/sec at 0.8 Hz, an approximate four (4) fold increase. (FIG. 12)

Vertical Electrode Measurements

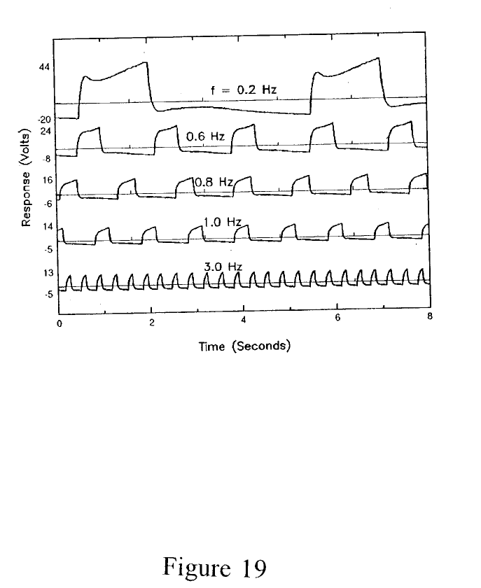

FIG. 19 shows an example of the resulting voltage response from one embodiment of a vertical electrode device with a 130 μm wide porous plug to the zero averaged injected current signal at different frequencies with 30% duty cycle and +350 and −150 nA amplitudes. The voltage response of the fr-EOF is non-linear and changes with frequency.

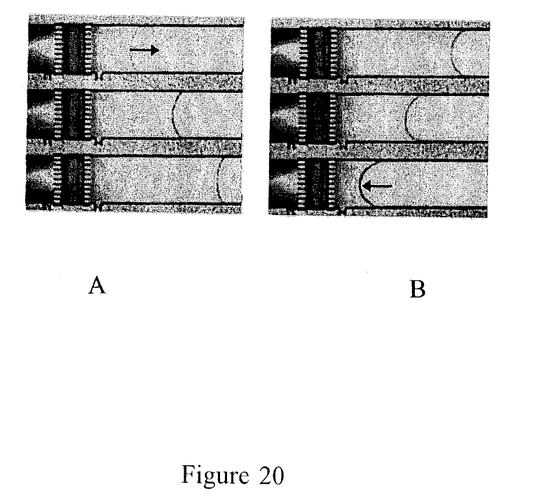

Water-air interface movements in response to applied current signals were recorded using the measurement system shown in FIG. 18 are shown in FIG. 20. Corresponding to the voltage response data, a 30% duty cycle step current signal with +350, −150 nA amplitudes at different frequencies was applied to the device, and the de-ionized water-air interface movement was recorded (note these are smaller amplitudes than those used for embodiments of the planar electrode device).

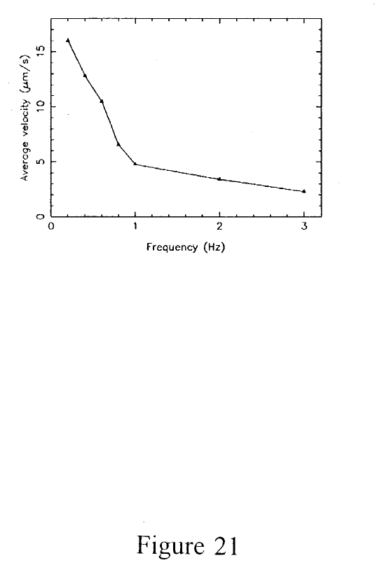

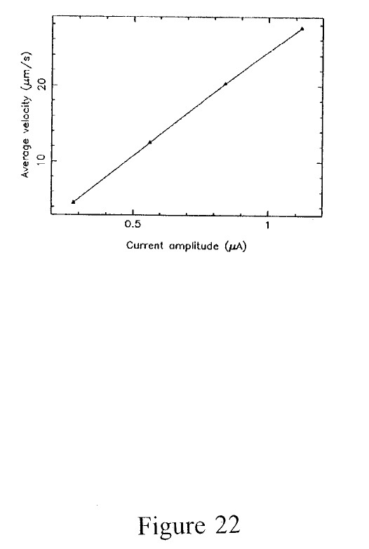

The resulting fluid velocity is a function of the frequency of the injected signal. FIG. 21 shows the frequency response of the net velocity of water-air interface. The maximum velocity was 16 μm/sec. FIG. 22 shows the effect of increasing amplitude of the applied current signals on average velocities. The same frequency and duty cycle step current signals whose amplitudes are multiples of +280, −120 nA were applied to a device having a 100 μm wide plug. Average velocities show a linear increase with increasing amplitudes. However, a limitation occurs wherein increased amplitude eventually results in bubble generation. If the amplitude increases beyond a threshold during either the positive or negative cycle, an unstoppable vigorous bubble generation happens before the opposite cycle can start to reverse the reactions.

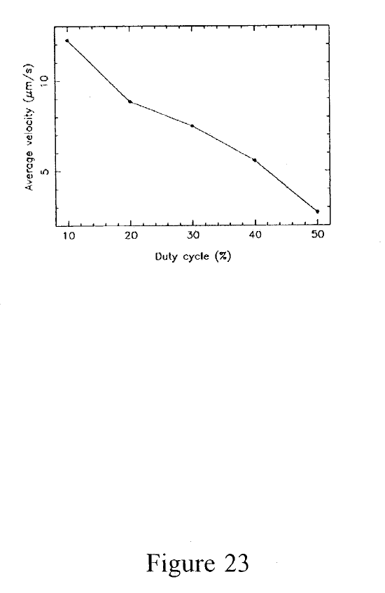

FIG. 23 shows the effect of duty cycle on average velocities. Signals at the same frequencies were applied having the same “amplitude×duration” product. Velocities are observed to increase with smaller duty cycles. This implies that short current pulses with high amplitudes produce higher velocities. However, a limitation occurs wherein increased amplitude eventually results in bubble generation. Similar to the previous case, if current amplitude increases beyond a threshold at a lower duty cycle, an unstoppable bubble generation happens before an opposite cycle can even start.

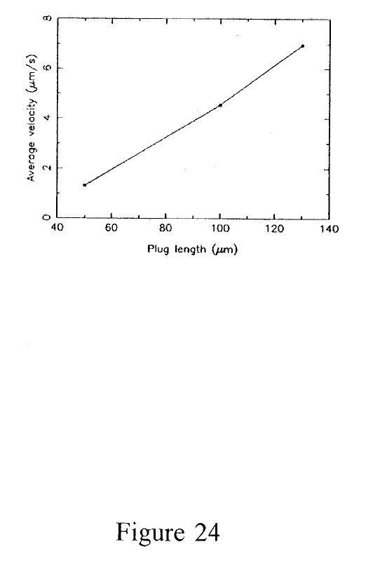

FIG. 24 shows increased average velocities of pp-EOP devices with increasing plug width. Specifically, the same current signals were applied to different devices having different plug widths. FIG. 24 shows an approximate quadrupling in velocity for a doubling of plug width. However, this relationship may not be quantitatively precisely accurate since these data are collected from different devices that are cast from different molds. While comparing different devices from different molds, not only their plug widths might be different but also other parameters like channel surface roughness and defects and/or trapped air within the plug also may affect flow velocity. Importantly, the same device was used to collect data presented supra showing voltage versus frequency and velocity versus frequency relationships and those data showing current amplitude and duty cycle relationships. When using the same device to compare different data sets, any parameter affecting flow velocity would have the same effect on every data point, therefore, it will not obscure any relationships. It is important to point out in this experiment, that even though the observed increase in velocity may not be exactly quadruple, there is a significant increase in velocity in relation to plug width.

While it is not necessary to understand the mechanism of the invention it is believed that the flow velocity/plug width relationship is due to an increase in surface area of solid walls that interacts with the liquid and enables the electric field to drag the liquid. One skilled in the art might suspect that this effect would be cancelled by a reduction in electric field magnitude and increased impedance resulting from an increase in electrode gap distance. Surprisingly, this does not happen. The application of the same current amplitude is one possible explanation. The present embodiment results in a larger voltage value established across the porous polymer plug for the same current amplitude, therefore keeping the electric magnitude fairly constant.

While this invention has been described in reference to illustrative embodiments, this description is not intended to be construed as a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

We claim:

1. A composition, comprising:
a) a cast polymer comprising pores; and
b) a wafer adhered to said polymer.

2. The composition of claim 1, further comprising a metal mask defined on a top portion of said polymer, wherein the unmasked top portion of said polymer is etched.

3. The composition of claim 1, wherein said pore sizes are within the range of 1 nm and 1 μm.

4. The composition of claim 1, wherein said pores are of a size such that fluid can flow through the polymer.

5. The composition of claim 1, wherein said polymer is poly(butyl methacrylate-co-ethylene diamethacrylate-co-2-acryloamide-2-methyl-1-propanesulfonic acid.

6. The composition of claim 1, wherein said wafer comprises silicon or glass.

7. The composition of claim 1, wherein said wafer is etched.

8. The composition of claim 1, wherein said metal mask comprises chromium and aluminum.

9. A method, comprising:
a) providing:
i) a monomer solution;
ii) a casting mold;
iii) a heat source;
iv) an adhesion promoter, and
v) a wafer;
b) coating said casting mold with said adhesion promoter to create a coated mold;
c) pouring said monomer solution into said coated mold;
e) placing said wafer on said monomer solution in said coated mold to create an enclosed mold;
f) heating said enclosed mold with said heat source until said monomer solution polymerizes, so as to create a porous polymer.

10. The method of claim 9, further comprising coating a portion of said porous polymer with a metal mask so as to create a masked and unmasked portion.

11. The method of claim 10, further comprising etching said unmasked portion of said porous polymer, so as to create a patterned porous polymer structure.

12. The method of claim 9, wherein said monomer solution comprises at least two monomers and a solvent.

13. The method of claim 12, wherein said monomer solution comprises 1-propanol and buteniol.

14. The method of claim 13, wherein said 1-propanol ranges between 70% and 85%.

15. The method of claim 9, wherein said casting mold comprises silicon.

16. The method of claim 9, wherein said adhesion promoter is gamma-methacryloxytropyl trimethoxy saline.

17. The method of claim 9, wherein said wafer comprises silicon or glass.

18. The method of claim 9, wherein said wafer is etched.

19. The method of claim 10, wherein said metal mask comprises chromium and aluminum.

20. A method, comprising:
a) depositing an insulation layer onto a substrate;
b) creating an electrode pattern on said insulation layer; and
c) placing a porous polymer structure within said electrode pattern.

21. The method of claim 20, further comprising layering a photoresist layer over said patterned porous polymer structure and said insulation layer, thus forming a patterned porous plug mask.

22. The method of claim 21, further comprising removing said photoresist layer from a small section on top of the patterned porous plug mask.

23. The method of claim 22, further comprising depositing a parylene-C layer over said pattern porous plug mask.

24. The method of claim 23, further comprising etching said photoresist layer thus forming channel walls, electrode openings, escape hole, reservoir openings and channel exit openings, wherein a porous plug electro-osmotic pump is formed.

25. The-method of claim 20, wherein said substrate comprises silicon.

26. The method of claim 20, wherein said insulation layer comprises parylene C.

27. The method of claim 20, wherein said parylene C layer is preferably 5 μm thick.

28. The method of claim 20, wherein said electrode pattern comprises gold.

29. The method of claim 20, wherein said channel walls are with the channel necked down to either 50 μm or 20 μm.

30. An apparatus, comprising;
a) a substrate having an insulation layer;
b) an electrode pattern layered on said insulation layer;
c) a porous plug contacting said electrode pattern, wherein said plug comprises pores of a size allowing fluid flow through said plug.

31. The apparatus of claim 30, further comprising a channel wall attached to said porous plug and said insulation layer thereby defining an upstream portion and a downstream portion.

32. The apparatus of claim 31, wherein said upstream portion comprises a reservoir opening and escape hole in said upstream portion.

33. The apparatus of claim 32, wherein said downstream portion has a channel exit hole.

34. The apparatus of claim 30, wherein said substrate comprises silicon.

35. The apparatus of claim 30, wherein said insulation layer comprises parylene-C.

36. The method of claim 35, wherein said parylene C layer is preferably 5 μm thick.

37. The apparatus of claim 30, wherein said porous plug comprises 1-propanol and buteniol.

38. The apparatus of claim 30, wherein said pores have a size within the range of 1 μm and 1 nm.

39. The apparatus of claim 30, wherein said electrode pattern comprises gold.

40. The apparatus of claim 30, wherein said channel walls are with the channel necked down to either 50 μm or 20 μm.

41. A method, comprising:
a) providing;
i) an apparatus, comprising;
a) a substrate having an insulation layer,
b) an electrode pattern layered on said insulation layer,
c) a porous plug contacting said electrode pattern, wherein said plug comprises pores of a size allowing fluid flow through said plug,
d) a channel wall attached to said porous plug so as to define first and second sides of a channel, and
e) a reservoir on said first side of said channel;
ii) an alternating current power source having a frequency within the range of 0.1 and 10 Hz, wherein said alternating current power source is connected to said electrode pattern; and
iii) a dielectric liquid;
c) filling said reservoir with said dielectric liquid; and
d) applying an electricalal potential across said electrode pattern using said alternating current power source whereby at least some of said dielectric liquid flows through said porous plug to said second side of said channel.

42. The method of claim 41, wherein said substrate comprises silicon.

43. The method of claim 41, wherein said insulation layer comprises parylene-C.

44. The method of claim 43, wherein said parylene C layer is preferably 5 μm thick.

45. The method of claim 41, wherein said pattern porous plug comprises 1-propanol and buteniol.

46. The method of claim 41, wherein said pores range have sizes within the range of 1 μm and 1 nm.

47. The method of claim 41, wherein said electrode pattern comprises gold.

48. The method of claim 41, further comprising a direct current power source operably connected to said electrode pattern.

49. The method of claim 48, wherein said electrode pattern is protected by a layer of dielectric thereby preventing contact with said liquid.

50. The method of claim 41, wherein said alternating current power source operates within a voltage range of 0.1-50 V.

51. The method of claim 41, wherein said alternating current power source operates at a preferred duty cycle of 30%.

52. The method of claim 41, wherein said channel walls are with the channel necked down to either 50 μm or 20 μm.

53. A method for moving microdroplets, comprising:
a) providing a liquid microdroplet disposed within a microdroplet transport channel etched in silicon, said channel in liquid communication with a reaction region via said transport channel and separated from a microdroplet flow-directing means by a liquid barrier, wherein said microdroplet passes through a porous polymer; and
b) conveying said microdroplet in said transport channel to said reaction region via said microdroplet flow-directing means.

54. The method of claim 53, wherein said flow-directing means comprises a series of aluminum heating elements arrayed along said transport channel and the microdroplets are conveyed by differential heating of the microdroplet by the heating elements.
